(19) United States
(12) Patent Application Publication
(10) Pub. No.: US 2013/0144748 A1
(43) Pub. Date: Jun. 6, 2013

(54) METHOD AND SYSTEM FOR CUSTOMIZING FOOD SERVICE ARTICLES

(71) Applicant: WADDINGTON NORTH AMERICA, INC., Chelmsford, MA (US)

(72) Inventors: Ashish K. Mithal, Chelmsford, MA (US); Curtis Heverly, Glendale, CA (US); Michael G. Evans, Cincinnati, OH (US)

(73) Assignee: WADDINGTON NORTH AMERICA, INC., Chelmsford, MA (US)

(21) Appl. No.: 13/706,185

(22) Filed: Dec. 5, 2012

Related U.S. Application Data
(60) Provisional application No. 61/566,815, filed on Dec. 5, 2011.

(51) Int. Cl. G06Q 30/06

(52) U.S. Cl. CPC G06Q 30/0621
USPC 705/26.5

(57) ABSTRACT

The present invention provides a method for a customer to interact with a computer system over a computer network for specifying custom decoration of a plastic food service article. A computer-assisted decorating machine then processes the customer input and customizes the food service article according to the customer input. Thereafter, the customized article is delivered to the customer. Creation of customized and/or personalized designs is rendered feasible by providing readymade templates for a variety of events and occasions. In embodiments, the computer-assisted decorating machine is a laser marking system, and the food service articles are made from a plastic material that discolors when irradiated with a laser beam. The markings can emulate silver, gold, or pewter without applying metals, inks, or coatings to the plastic articles, and laser marked plate products can resemble decorated china plates or other permanent ware articles.

### RELATED APPLICATIONS

This application claims the benefit of U.S. Provisional Application No. 61/566,815, filed Dec. 5, 2011, which is herein incorporated by reference in its entirety for all purposes. This application is also related to application Ser. No. 13/705668, filed on Dec. 5, 2012, which is incorporated by reference in its entirety for all purposes.

### FIELD OF THE INVENTION

This invention relates generally to methods for customizing food service articles; more particularly, this invention relates to a method and system for utilizing computer communication for customizing a food service article for a specific event, function or occasion according to customer input and including custom indicia in the form of a mark, message, pattern, image, or photograph on the food service article.

### BACKGROUND OF THE INVENTION

Disposable food service items such as containers, plates, trays, bowls, cups, and cutlery are in increasingly widespread use in all food related industries, including restaurants, caterers, institutional food service establishments, cafeterias, and households for storing, serving and consuming food, due to their reasonably low-cost and the convenience they provide. The increasing popularity of fast-food restaurant chains further fuels the demand for plastic tableware and takeout packaging. In addition to fast food restaurants, caterers also prefer disposable food service items for the associated convenience, hygiene, and competitive costs. Disposable food service items are also used at a variety of private, corporate and public functions and events.

Food service articles often feature decorative treatments applied to a surface thereof for a variety of reasons, including product identification, appearance enhancement, promotion, advertising, and/or providing instructions. The prior art yields a variety of methods for decorating plastic articles, including printing, labeling, hot stamping, heat transfers, and metalizing.

Despite numerous printing and decorating technologies being available in the marketplace, there remain unmet and unrecognized needs.

For example, there remains a natural need and demand for bridging the perception gap between disposable food service articles and their permanentware counterparts, so that disposable items may offer both aesthetic appeal as well as functional equivalence. For instance, Waddington North America, Inc., the assignee of the present invention, sells a line of printed dinnerware plates under the Masterpiece™ brand name that simulates china plates, and, a line of cutlery articles under the Reflections™ brand name that simulates fine metal silverware. In addition to these WNA offerings, other companies offer dinnerware items such as plates and bowls that display a foil-stamped metallic appearance on the rims of the articles. These types of disposable food service products attempt to simulate their permanentware counterparts, and also offer the convenience of disposability, but may still not be perceived as equivalent to permanentware by some customers. Therefore, there is a need to further enhance the perception of value offered by upscale disposable products.

These and other needs are met by the system and method of the present invention.

### DEVELOPMENT OF THE INVENTION

Until the present invention, the chief objective of creating high-end disposable food service items was to provide a disposable product that simulated permanentware in appearance, and was functionally adequate for its intended use. The inventors recognized, however, that to truly enhance the perception of value of disposable food service articles, these products must offer something that their permanent counterparts cannot readily offer. This recognition led to the understanding that customizing a disposable food service article offers a novel approach to adding value to disposable products and distinguishing them over their permanentware counterparts. Permanentware items are usually purchased by consumers, caterers and restaurants for a plurality of uses, and therefore customizing permanentware for a specific event or function would be inconsistent with their intended purpose. Since customized food service articles would be needed just for the specific event or occasion for which they were ordered, they would likely be discarded after use at the intended event or occasion. Accordingly, customized disposable food service articles offer a benefit that cannot be readily duplicated, or at least economically attained, with permanentware. Therefore, although the present invention can be implemented for decorating and customizing a variety of food service articles, it is particularly applicable to disposable, single use food service articles.

The need for customizing and personalizing food service articles has hitherto not been recognized or addressed in the marketplace due to a lack of a comprehensive technique, system, and/or methodology. The inventors also recognized that the need for customizing food service articles has been mostly unaddressed because quantity requirements for occasional functions and events, such as birthdays, anniversaries, weddings, and meetings, were expected to be fairly modest. While certain institutional customers might satisfy large quantity requirements for custom decorated products, the quantities of customized food service articles needed by most customers for their specific events or occasions would be limited to the expected usage at such events.

In addition, it was expected that most custom orders would be unique, as customization may mean different things to different people, so that even returning customers of customized food service articles might not want the same customization that they previously ordered. Thus, prior to the present invention, personalization or customization of disposable food service articles had been economically infeasible or unviable for personal, family and social events such as birthdays, anniversaries, weddings, and meetings for the majority of customers because of short-run requirements for most such events, in contrast with long-run requirements for attaining reasonable pricing on disposable items decorated using traditional techniques.

Customization of items such as business cards, letterhead, certificates, and other flat paper items produced in small quantities is well known. However, there are several issues which render a similar approach impractical for food service items produced in small quantities. It would be useful to discuss the development of the invention in light of the prior art.

A common method of decorating food service articles is by printing an image, graphic or text on one or more surfaces of the articles, usually by offset printing, screen printing, or pad printing. It has been the experience of the inventors that manufacturers of food service articles and food processors generally print products in relatively large quantities that may exceed thousands of pieces, so that printing set-up and changeover costs can be distributed over the entire run for economic reasons. Therefore, in the prior art a lot of attention has been paid to maximizing the efficiency and speed of large printing operations geared towards the need of fulfilling sizeable orders from institutional customers. These efforts, however, do not address the needs of customers who may require shorter runs. In addition, shorter runs may be necessary for special and custom situations. Therefore, there is a need for commercially viable technologies and methods that will enable and facilitate decorating food service articles in smaller batches.

Traditional printing techniques, however, do not lend themselves to customizing food service articles because these processes require additional pre-press work once the artwork for printing has been created. Pre-press work may involve creating a master plate, a stencil, or a cliché, and other preparatory work before even a single food service article can be printed.

Once pre-press work has been completed, food service articles can be printed on a commercial scale in relatively large quantities with these techniques. However, traditional printing techniques do not readily permit small quantities of customized or personalized content to be printed economically, due to the cost of the pre-press work required and other preparatory and changeover costs associated with switching from one printing pattern to another. Costs associated with a changeover from a first printing pattern to a second printing pattern include creation of an additional printing plate or cliché, ink clean-up, installation of the new printing plate, and other preparatory activities. Therefore, creating a unique or customized printing pattern for a customer with traditional printing techniques inevitably requires minimum order quantities, which can easily be tens of thousands of pieces for economic reasons. Otherwise, the customer would incur significant set-up and changeover expenses.

In addition, traditional printing processes suffer from other shortcomings when applied to food service items. Traditional printing techniques inevitably require the use of ink and handling ink related issues. Aspects of ink management include ensuring that selected inks are suitable for use on food service articles, that ink ingredients are deemed safe in toxicological evaluations, that the method offers adequate adhesion with substrate material, and that the inks are completely dried or cured. Accordingly, it is desirable for printing on food service articles that either the selection of inks is limited to ink types that will be suitable for food contact, or the printed image is protected from direct food contact with the ink by applying a barrier overcoat to guard against accidental migration of inks into food. While adequate ink adhesion would be normally required for printing a substrate material for use in any kind of application, it is particularly essential in food-service applications, because poor adhesion may lead to migration of inks into foods and cause food contamination and/or health hazards. Ensuring that the inks are completely dried or cured, and that any solvents are removed and/or reactants are neutralized, is critical to ensuring that the ink will remain adhered to the food service substrate, and will not become a food additive.

Thus, ink management practices frequently require the use of secondary processes which add to the cost and complexity of the operation. For instance, ensuring adequate adhesion may require subjecting a food service article to a corona treatment or flame treatment prior to printing thereon, in order to remove any surface compounds, processing aids, or other materials that may exude or bloom to the surface of plastic materials after molding or forming operations. In addition to the adhesion-promoting pretreatment, printing a food service article may require a post-treatment in the form of a barrier or protective overcoat. One of the disadvantages of using a barrier overcoat is that it detrimentally affects the vibrancy of the underlying print, but is required due to food contact reasons. It has been the experience of the inventors that a barrier overcoat on black or other dark colored food service plate surfaces significantly mars or impairs the appearance of the printed pattern or graphic, and the luster of the underlying dark color.

Another method of decorating plastic food-service articles is by transferring a pre-printed pattern onto the surface of an article. Once again, this method does not readily facilitate customization, because the pattern has to be printed onto the transfer medium using traditional printing techniques and then transferred onto the desired substrate via heat and pressure. Similarly, foil stamping does not provide a viable method for customizing food service articles because foil stamping still requires creation of a die for stamping a pattern onto the surface of a substrate. Foil-stamped plates are currently being sold in the marketplace with the purpose of emulating permanent ware. However, a shortcoming of this method is that the foil-stamped portions of the plate surface cause arcing in a microwave oven, and may create other electrical and fire hazards in use.

Thus, it can be firmly established that traditional printing and decorating techniques do not viably address customization of food service articles.

The above insights led the inventors to recognize that customization and personalization of food service articles for various events and occasions can serve as means for adding value to disposable food service items and distinguishing these products from their permanentware counterparts. However, the hurdles that remained to be overcome included overcoming the problems of prior art with respect to long-run requirements with traditional printing techniques, addressing the fact that even upscale disposable products that simulate permanentware cannot readily be customized with traditional printing techniques, addressing the lack of a technique for creating customized food service products in a reasonably price-effective manner without resorting to long runs, and addressing the lack of availability of a system to customers for customizing food service products for their personal events and occasions. Therefore, an object of the present invention is to overcome the hurdles identified above and the disadvantages of the prior art.

Thus, there is a need for facilitating customization of food service articles for events, functions and occasions via a decorating technique for plastic plates and other disposable food service articles which does not require long runs, and does not require the use of inks, foil stamps, heat transfers, metallic coatings, or labels. These and other needs are met by the food service articles and method of the present invention.

It is important to mention here that the disadvantages of the prior art, viz. printing via traditional printing techniques, only became acutely apparent because of the insight that customizing of food service articles cannot be readily implemented by utilizing traditional printing technologies, because they require long product runs while customization requires short and extremely short runs. It is counter-intuitive in the sense that typically long runs on large and sophisticated printing presses are considered favorable for maximizing efficiency.

### BRIEF SUMMARY OF THE INVENTION

### Decorating System

At the heart of the present invention is the discovery of an unexpected result, namely that the right combination of laser wavelength, laser power, plastic substrate, and colorant can yield a high contrast and aesthetically pleasing decoration for customizing disposable food service items and/or simulating permanentware articles without utilizing inks, foils or metallic coatings. The inventors had the insight that almost all conventional printing processes require transfer or placement of a printable pattern via direct contact between a master and a substrate, and this unavoidable aspect makes these techniques unsuitable for short run customization of food service products. In accordance with the present invention, a non-contact method for decorating food service articles by laser marking is used for customizing food service articles. This technique obviates the need for creating a master, a printing plate, a stencil or a cliché as is required in the prior art, and makes short runs viable, substantially removing key impediments to customization of food service articles. Laser marking does not involve the use of inks. Therefore ink-associated issues relating to ink toxicology, adhesion, curing, and clean-up are also avoided. In addition, any secondary processes to improve ink-adhesion are avoided, and the need for protecting ink via protective coatings or barrier layers is also obviated.

In the prior art, laser marking applications have mostly involved placing relatively small portions of alphanumeric information, such as date codes, serial numbers, batch numbers, part numbers, lot numbers, and machine readable UPC-type markings, on packaging or plastic substrates. US Pat. Pub. 2008/0124433 lists some of the examples of the use of laser marking in the food industry, including marking of two dimensional codes on eggs, date-code markings on plastic bottles, and marking of cheeses and fruits as a means of tracking, identification, promotion and advertising.

Thus, while laser marking has been traditionally used in packaging applications for product identification, inventory and stock control, and product tracking purposes, it fundamentally involved placing functional markings which were not required to be prominently conspicuous, and did not provide a readymade way to decorate and customize food service articles. In particular, application of laser marking for decorating plastic food service articles, and specifically articles that are intended to simulate permanentware counterparts, was hitherto unknown. Furthermore, laser marking on surfaces that come in actual food contact, such as the top surface of a plate or a tray that also offers a decorative effect, was also unknown.

Pursuing laser marking technique(s) for decorating food service articles posed a number of challenges.

Firstly, while laser marking is functionally adequate for placing date codes, UPC codes, and other alphanumeric data on plastic products, decorating plastic plates and other articles requires that the marking be very conspicuous, attractive, and offer a distinctive visual appeal. For instance, achieving a relatively conspicuous mark on, for example, a plastic plate may be enough for coding purposes, but may not provide a decorative effect that simulates a china plate which includes silver or gold colored patterning. Thus, a laser marked decorative pattern on a plastic plate must also offer the desired appearance, color contrast, and some degree of reflectivity for offering the impression of a china plate.

Secondly, decorating a relatively large surface of a food service article such as a plate may require a much longer marking time than simply marking text, which may render the technique uneconomical for decorating food service articles.

Thirdly, depending on the area of decoration, laser radiation may lead to overheating and melting of the plastic products, or produce a rough surface texture, causing an undesirable feel and a possibility that particulate matter from the marked region may separate from the plastic article and may contaminate foods. Thus, there was no reasonable expectation of success that a laser marked surface of a food service article would be aesthetically and functionally acceptable and would be suitable for food contact.

Fourthly, depending on the wavelength of the laser beam, the interaction between the laser beam and the plastic substrate produces different effects which may not be deemed attractive enough from a decorating standpoint.

Given these expectations and the problems outlined above, laser marking was not significantly explored before the present invention for decorating food service articles.

Other difficulties associated with decoration of plastics by laser marking included developing the correct match between the plastic substrate and the laser beam wavelength for optimizing absorptivity of laser radiation. When a light beam strikes the surface of an object it can interact in the following ways: some of it is reflected from the object, some of it may be absorbed by the object, and the rest is transmitted through the object. Therefore, if the laser radiation is substantially reflected by or transmitted through the plastic substrate, then there will be very little interaction between the laser beam and the plastic substrate, and hence the markings will be relatively weak, i.e. lacking sufficient contrast.

Thus, in order to achieve a visible laser mark on the surface of a plastic article, there must be some degree of absorption of the laser energy by the plastic material. The difficulty this posed is that most of the plastics used for food service articles are naturally transparent or translucent, and even non-clear food service articles are produced by adding just the requisite amount of colorant for achieving the desired appearance. Various approaches for enhancing the absorptivity of laser radiation for achieving a distinct mark are described in the art. One approach is to coat the article with a material that will readily change color upon exposure to laser light. However, this requires a more complex manufacturing process, and can significantly increase the cost of a food service article such as a plastic plate. In addition, toxicity of the coating material can be a safety concern, if there is any chance that the adhesion of the coating may be less than perfect. For example, US Pat. Pub. 2008/0131563 describes a food-compatible laser-imageable coating and indicates that many laser-imageable coating components are not food-compatible.

Another approach for enhancing laser absorptivity is to add a secondary laser-absorbent substance or pigment to the plastic itself, and a variety of pigment compositions are described in the prior art. Laser marking pigments are also available commercially. For example, Eckart America Corporation sells a laser marking additive under the brand name LASERSAFE. It is well known that plastic products are normally produced in a desired color by incorporating colorants or dyes during molding or forming operations. However, including a secondary laser-absorbing pigment or additive may significantly increase the cost of the article, and may adversely affect the appearance or color of the article.

In experiments, the inventors also witnessed that food service articles out-gassed during laser marking and left fine particulate deposits on surfaces thereof. Fine particulate matter was very noticeable at certain process settings, despite the fact that a vacuum exhaust for removing process fumes was operational during laser marking. This was of particular concern as any visible residue on a food service article, such as a plate, would be very unsightly and make it unfit for use in food contact applications.

The present invention addresses the above challenges; and inter alia teaches a plastic food service article that is decorated by laser marking. The food service article is made from a thermoplastic resin, such as polystyrene, polypropylene, polyethylene, polyethylene terephthalate, etc., and is tinted by adding a colorant to the plastic, such as a dye or pigment, so as to impart a desired color or appearance to the final article. A variety of colorants can be used in food service articles for obtaining a variety of colors. Many or most of them can be used in the present invention. For example, white food service articles that employ titanium dioxide as a colorant, and black food service articles that employ carbon black as a colorant are compatible with the present invention. The laser marking process itself does not involve the use of inks on the article.

In exemplary embodiments of the invention, no special laser absorptive substances are added to the plastic products other than customary tints or colorants which may be included for imparting a desired color or appearance to the plastic article. In some exemplary embodiments, laser marking is provided on surfaces that come in actual contact with food, such as the top surface of a plate or tray. In some embodiments, deposition of fine particulate during marking was controlled by blowing ionized air onto the surface of the part for eliminating static and assisting the escape of gaseous and particulate matter through the exhaust.

The method of decorating food service articles according to the invention includes exposing a surface of the article to a high intensity laser beam, produced in some embodiments by a YAG laser or a Fiber laser, the beam exposure causing localized surface absorption of the laser radiation by the colored plastic substrate and consequent heating of the plastic sufficient to cause localized surface foaming or discoloration of the plastic in a precisely defined region that is distinguishable from both light and dark backgrounds. It will be apparent that various laser types can be utilized for accomplishing the objects of the invention including lasers that operate at wavelengths in the ultraviolet region (e.g. 355 nanometers UV laser); visible region (e.g. 532 nanometers Green laser); and infrared region (e.g. lasers operating at 1062 nanometers, or 1064 nanometers, or 1070 nanometers).

The inventors have observed that lasers operating in the far infrared region (CO₂ lasers operating at 10.6 microns) do not provide a high color contrast, but simply engrave the surface of the plastic. CO₂ lasers have been tried in the past for marking lids, but have not been commercialized in the marketplace, perhaps due to lack of contrast and quality of marking.

In certain embodiments of the invention, the food service articles can be molded from plastic resins such as general-purpose polystyrene, high-impact polystyrene, polyethylene, polypropylene, polyethylene terephthalate (PET), polylactic acid (PLA), styrene acrylonitrile (SAN), acrylonitrile-butadiene-styrene (ABS), styrene-butadiene-copolymer (SBC), poly(methyl methacrylate) (PMMA), polycarbonate or a mixture and/or a copolymer thereof. In various embodiments, the laser intensity and beam deflection are controlled by a computer so as to produce a pattern defined by software instructions.

In some embodiments and design variants, the laser marking operation requires between 0.5 seconds and about 5 seconds for decorating an entire tableware article such as a plate or cup. Nonetheless, extremely intricate artwork and high resolution photographs may require 30 to 90 seconds or even longer in terms of marking time on a 10″ plate. It will be appreciated by skilled artisans that marking times can be influenced by a variety of factors, including the speed of marking, the size and quality of the graphic artwork, the level of detail and intricacy of the graphic artwork, the resolution used for marking, and the absorptive properties of the plastic-colorant combination.

One of the benefits of decorating by laser marking is that the decoration is applied in a non-contact manner without distorting or deforming the article or any portion thereof, thereby allowing decoration to be applied or scribed over various surfaces of an article, including non-planar surfaces and three-dimensional features. Accordingly, a feature of the present invention is to provide a method for decorating a food-service article that includes a plurality of surfaces comprising at least one of a flat surface, a single curvature surface, a concave surface, a dual curvature surface, and a multi curvature surface. For example, a plate having a molded-in pattern in the form of flutes, scallops, or a similarly ornate pattern can be laser-marked without undue distortion of either the mark or the plate itself.

Another feature of the present invention is that a display graphic can be placed on a complex surface without undue manipulation of the artwork.

An additional feature of the present invention is to provide a method for applying custom decorations to food-service articles for a variety of events and functions, including birthdays, weddings, anniversaries, sports events, corporate gatherings, and such like, in relatively low quantities at a reasonable cost.

### Customization System and Method

The inventors recognized that in addition to printing technique hurdles, there are infrastructure and system hurdles in customizing food service articles; for instance, while a customer may want customized food service articles for their specific event or occasion, they might not be readily able to specify exactly the type of customization that would be suitable for their particular event or occasion. Furthermore, since customization may mean different things to different people, the system should be sufficiently flexible to accommodate a variety of user requests and customization needs for a variety of use situations, events and occasions. The present invention addresses the need for such a system.

Accordingly, a computer-assisted method and system for customizing a food service article is disclosed. According to an aspect of the invention, the present invention provides a method for a customer to interact with a computer system over a computer network, for specifying custom decoration of a food service article. A computer-assisted decorating machine then processes the customer input and customizes the food service article according to the customer input. Thereafter, the customized article is delivered to the customer.

According to embodiments of the invention, the customizing system displays available templates for customizing a food service article to a customer or purchaser over a computer network. A template is simply a digital representation or an image of a food service article showing at least a portion of the food service article that can be customized. The template may indicate the basic type of food service article, and other attributes such as its color and size. The customizable portion in a specific template may be in the form of a text element, an image, a graphical element, or a photograph. After the customer selects a particular template, the customer is then directed to provide input corresponding to the nature of the customizable portion for that specific template. Input may be supplied by entering text into a text field or by uploading an image or a photograph. Customer input may also be a selection of at least one of text, images, patterns, characters and photographs from a design library.

The system may define specific limitations for customer input in terms of customizable elements; for instance, the system may pose limitations with regard to number of characters for text entries, font types and sizes, image size and resolution, portion of the plate to which customization can be implemented, and so forth. Once the system accepts the custom input provided by the user or purchaser, the system then converts the custom input to a file type that is processable by a decorating machine computer system.

Accordingly, a feature of the present invention is to provide a system and method for enabling a user to engage interactively with a computer server for selecting and designing food service articles with custom decoration or indicia for a specific event, function, or occasion, including birthdays, weddings, anniversaries, sports events, corporate gatherings, and such like, and to submit an order to purchase the same.

According to an embodiment of the invention, a computer-assisted decorating system receives the order for customer product along with information for customizing the selected food service article. The computer-assisted decorating system converts user input into a processable file, the desired custom information is marked by the decorating system, and the completed order is shipped to the customer.

One general aspect of the present invention is a method for providing a decorated foodservice article, said method comprising the steps of receiving an input over a computer network for decorating a foodservice article, converting said input to at least a file type, said file type being processable by a decorating machine computer system, applying a visible marking pattern on a surface of said foodservice article in accordance with said processable file, transforming said foodservice article to said decorated foodservice article, said application of said visible marking pattern being suitable for food contact, and controlling at least one of location, size, and prominence of said marking pattern on said surface of said foodservice article.

In embodiments, the method further includes evaluating said input prior to converting said input for at least one of artwork type, image resolution, file format, size, and font type.

In some embodiments, said step of applying said marking pattern is implemented by a laser beam. In other embodiments, said foodservice article comprises a plastic material. In certain embodiments said foodservice article comprises a paper substrate. In further embodiments said foodservice article comprises at least one of a plastic material, a paper substrate, and a metallic coating.

In various embodiments said foodservice article comprises a first material component and a second material component, said first material component having higher laser absorptivity than said second material component.

In some embodiments said visible marking pattern offers an appearance of printed ink without utilizing an ink composition. In other embodiments said visible marking pattern offers an appearance of a metallic coating without utilizing said metallic coating.

In various embodiments, said foodservice article comprises at least one of polystyrene, polyethylene, polypropylene, polycarbonate, PET, PLA, ABS, SAN, PMMA, and SBC.

In some embodiments, said foodservice article comprises at least a plastic material and at least a colorant. In other embodiments, said visible marking pattern on said surface of the foodservice article is difficult to detect by human touch. In certain embodiments said visible marking pattern on said surface of the foodservice article is detectable by human touch. And in further embodiments said visible marking pattern on said surface of the foodservice article provides a gold appearance.

In various embodiments, said visible marking pattern on said surface of the foodservice article provides a silver appearance. In certain embodiments said visible marking pattern on said surface of the foodservice article provides a pewter appearance.

In some embodiments said visible marking pattern on said surface of the foodservice article provides a white appearance. In other embodiments, said visible marking pattern on said surface of the foodservice article provides at least one of a gold appearance, a pewter appearance, and a silver appearance.

In embodiments, said surface of said foodservice article is non-planar. And in various embodiments said visible marking pattern is applied to a portion of the foodservice article comprising at least one of a flat surface, a non-planar surface, a single curvature surface, a multi-curvature surface, a fluted region, and a scalloped region.

Another general aspect of the present invention is a method for customizing a plastic foodservice article, where the method includes receiving an input over a computer network for customizing said plastic foodservice article from a customer, converting said input into a form processable by a decorating machine computer system, subjecting a surface of said plastic foodservice article to a laser beam, said laser beam having sufficient intensity to cause localized discoloration of said plastic foodservice article, controlling said laser beam through a software-based beam director implemented on said decorating machine computer system, and transforming said plastic foodservice article to customized plastic foodservice article by forming a visible marking pattern on said surface of said plastic foodservice article in accordance with said input received from said customer.

Yet another general aspect of the present invention is a method for customizing a plastic foodservice article, where the method includes offering a plurality of templates, over a computer network, for customizing said plastic foodservice article, said plurality of templates including at least a first template, said first template comprising at least a standard portion and a custom portion, receiving, over said computer network, a selection of at least said first template and an input corresponding to said custom portion of said first template from a customer, converting said first template into a custom file in accordance with said input, said custom file being in a form processable by a decorating machine computer system, applying a marking pattern on a surface of said plastic foodservice article by a laser beam, said laser beam having sufficient intensity to cause localized discoloration of said plastic foodservice article, controlling said laser beam through a software-based beam director implemented on said decorating machine computer system, and transforming said plastic foodservice article to customized plastic foodservice article by forming a visible marking pattern on said surface of said plastic foodservice article in accordance with said input received from said customer.

Still other features and advantages of the present invention will become readily apparent to those skilled in this art from the following detailed description, wherein we have shown and described only a few embodiments of the invention, simply by way of illustration contemplated by us in carrying out this invention. As will be realized, the invention is capable of other and different embodiments, and its several details are capable of modifications in various respects, all without departing from the scope of the invention.

The features and advantages described herein are not all-inclusive and, in particular, many additional features and advantages will be apparent to one of ordinary skill in the art in view of the drawings, specification, and examples of claims. Moreover, it should be noted that the language used in the specification has been principally selected for readability and instructional purposes, and not to limit the scope of the inventive subject matter.

### BRIEF DESCRIPTION OF THE DRAWINGS

The invention will be better understood upon reading the following Detailed Description in conjunction with the drawings, in which:

FIG. 1 is a block diagram of the customization system according to an exemplary embodiment of the invention;

FIG. 2 is a flow diagram showing method steps according to an exemplary embodiment of the invention;

FIG. 2A is the continuation of the flow diagram from FIG. 2;

FIG. 3 is a digital selection tool for customizing food service articles according to an exemplary embodiment of the present invention;

FIG. 4 shows an exemplary template for facilitating customization according to an exemplary embodiment of the present invention;

FIG. 5 shows another exemplary template for facilitating customization according to another exemplary embodiment of the present invention;

FIG. 6 shows another exemplary template showing user supplied graphic and text for facilitating customization according to another exemplary embodiment of the present invention; and

FIG. 7 shows a custom order according to another exemplary embodiment of the present invention.

### DETAILED DESCRIPTION OF THE INVENTION

For a comprehensive discussion of the present invention, it will be beneficial to define the various concepts, phrases and instrumentalities utilized in the present invention. In the following description, various functional aspects of the present invention will be described. However, it will be apparent to those skilled in the art that the present invention has a broader field of application than the exemplary embodiments set forth herein. Specific examples of customization templates, customer inputs, artwork, food service products, custom layouts, and product configurations are provided by way of illustration, in order to provide a thorough understanding of the present invention, and not by way of limitation. Furthermore, various operational elements of the system for customizing food service articles will be described in a particular order. However, the order of presentation is not necessarily the functional order of practicing the invention.

Customizing a food service article involves placing visibly distinct information or indicia, specified by the customer, on the food service article. Customer specified information may include textual content, graphical content, an image, a commercial message, a logo, and/or other indicia.

The term “computer system” is used broadly to refer to a device capable of processing, storing, accessing, manipulating, modifying, displaying, and transmitting information related to any aspect of the invention, and includes a general purpose computer as well as a special purpose computer system, such as a decorating machine computer system, which can be standalone, embedded, or networked.

The term “information” refers broadly to all data that can be represented or transmitted electronically or digitally. Information related terms, such as data, files, programs, text, images, graphics, bits, number, and characters, describing specific information types or representations or elements thereof, are used in consistency with their common use. It will be recognized by those skilled in the art that these data or information representations take the form of electrical, magnetic, or optical signals capable of being stored, accessed, copied, transferred, deleted, modified, combined, reproduced, captured, and/or otherwise manipulated through mechanical, electrical, and operational components of a computer system.

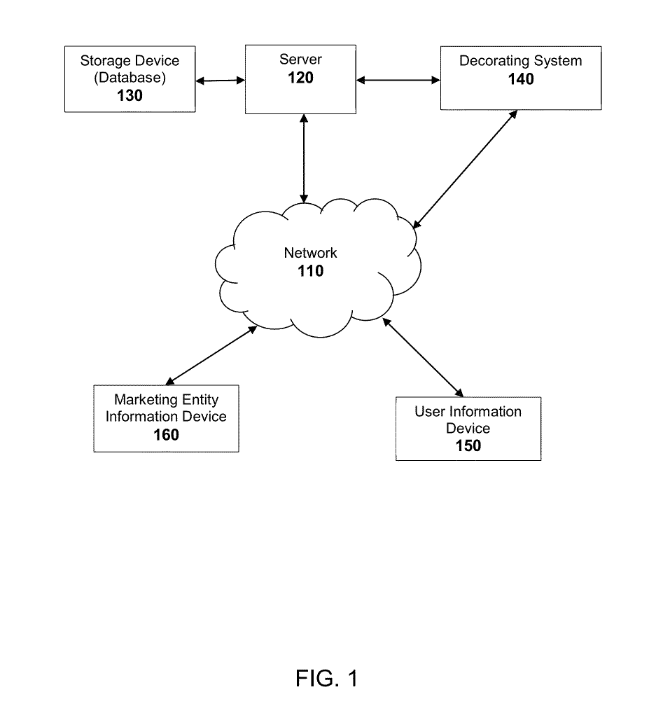

Referring to FIG. 1, there is shown a block representation of a customization system 100 according to an exemplary embodiment of the invention for customizing food service articles on demand. System 100 comprises a computer network 110, which can be public, private, internet, intranet, or some other network. Network 110 is capable of linking information devices for interactive communication, including sending, receiving, selecting, retrieving, and transmitting information. The communication link itself can be wire-based or wireless, and can utilize telephone lines, coaxial cable, fiber optics, or satellite communication links or networks.

System 100 can include a server 120 which can be accessed via computer network 110 by at least a user information device 150. In an embodiment of the invention, server 120 can be an HTTP server that is accessible over the internet. It will be realized that server 120 could be accessed by a plurality of users through a plurality of user devices. User information device 150 could be a personal computer, a notebook computer, a tablet, a phone, or other information device operated by a user or a potential customer.

According to an exemplary embodiment, server 120 can also be accessed by at least a marketing entity information device 160 over network 110. The marketing entity information device 160 could be a general purpose computer or a special purpose computer, and is operated by an entity authorized for marketing and selling customized products. A marketing entity information device 160 can be operated by an agent, an affiliate, a business partner, a franchisee, a reseller, a wholesaler, a retailer or an e-tailer. Accordingly, marketing entity information device 160 can be located at a variety of business locations, such as an office, a party store, a kiosk, a station, or a department within a large store. According to embodiments of the invention, the marketing entity could be a caterer requesting customized food service products on the customer's behalf for a customer event, for which the caterer is providing catering services. In certain exemplary embodiments, marketing entity information device 160 can function in a server mode and communicate with user information device 150 over network 110 to provide an alternate conduit to server 120 or to decorating system 140.

Server 120 is connected to a storage device 130. Storage device 130 can be configured to maintain information relating to a plurality of attributes, including, for example, usernames, user account information, user validation data, user addresses, marketing entity data, product inventory, customization templates, customization forms, rules, constraints, ordering information, shipping details, due dates, inventory, and order status, etc. Storage device 130 can store data in a format compatible with any of the data storage or database standards.

Server 120 is connected to decorating system 140 either directly or indirectly through network 110. In an exemplary embodiment, decorating system 140 is located proximate to server 120, while in other exemplary embodiments decorating system 140 is remotely accessible over network 110. It will be recognized that while the exemplary embodiment shown in FIG. 1 shows only one decorating system 140, a plurality of decorating systems can be provided at various geographical locations and selected for processing orders according to factors such as manufacturing ease, available inventory, available decorating capacity, status of pending orders, and/or geographical proximity to the ordering customer.

According to embodiments of the invention, a user or a potential customer can utilize user information device 150 for communication with server 120 for requesting, providing, receiving, and selecting information related to customizing a food service product, including information related to pricing, purchasing, and ordering.

If, the request from the user relates to a custom product based on a standard template already stored by server 120, and customer input is consistent with predefined parameters, then the server can confirm that the input is acceptable. Upon receiving confirmation that the input is acceptable, the customized product processing advances to the next stage. In some embodiments of the invention, the system provides an automated preview of a digital version of the customized product in accordance with the customer input, and awaits acknowledgement from the customer prior to further processing of the customer request. In some embodiments of the invention, the customer may be allowed to store digital versions of customized food service articles based on a plurality of templates in his or her account for a certain period of time, for reviewing and selecting between various options, such as template options, text options and graphic options, prior to placing an order for a custom product.

In situations where a user request is not based on a standard template and may require human intervention or expert help, the system can request additional information from the user for creating or quoting the desired custom product.

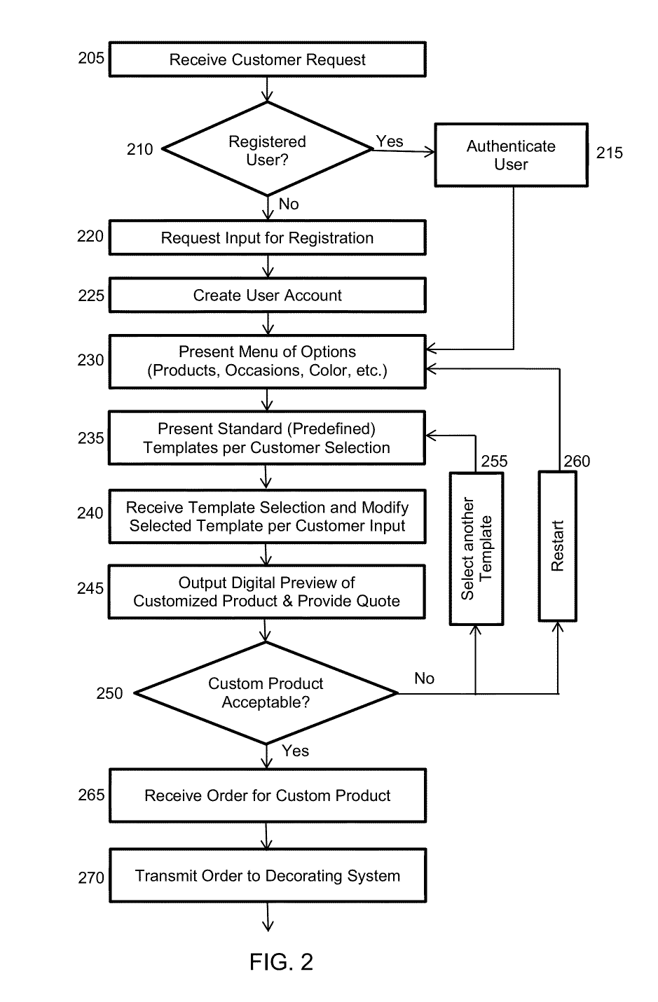

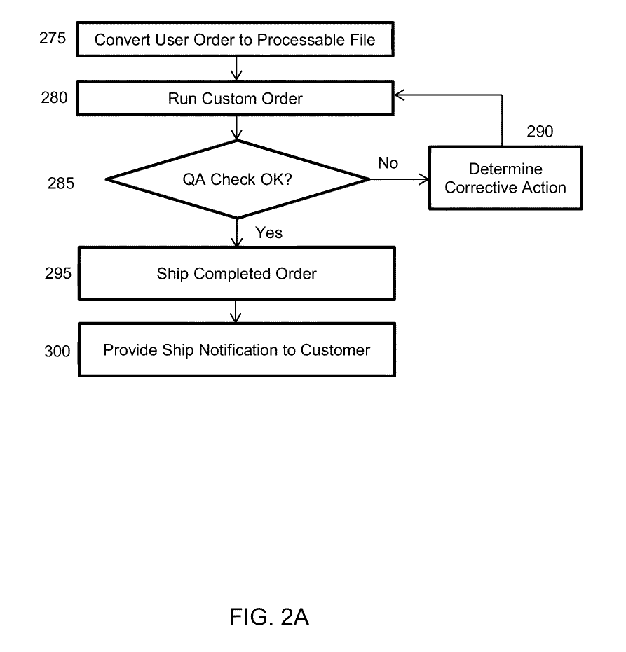

FIG. 2 and FIG. 2A present a flow chart delineating the steps of a method according to a preferred embodiment of the present invention. In step 205, a user may access an online storefront or website for the purposes of ordering customized food service articles, or for the purpose of designing (customizing) food service articles for later ordering. It will be realized that the storefront or website can reside on server 120, or it can be mirrored from or onto other servers that are operated or hosted by the system provider, a vendor, or a third party.

At step 210, the system verifies whether the user is a registered user and has an account on the system, or is a new user. If the user is already registered, the system awaits input from the user to authenticate pre-registered user (step 215). If the user is accessing server 120 from a personal device or home computer (user information device 150), authentication information can include login user identification and a user password as is known in the art. Alternately, a potential customer may access the system through a device provided by a marketing entity and located at a commercial location (marketing entity information device 160). In this case, the user can be authenticated through the marketing entity information device according to a sign-in procedure or protocol established by the marketing entity.

If the user is not a registered user, the system requests input from the user for becoming a registered user at step 220. Thereafter, at step 225, a new account can be created for the newly registered user for authorizing/enabling user interactions with the customization system for customizing food service articles.

Once a visiting user or potential customer has been converted to a registered user, or a previously registered user has been authenticated, the system can present the user with a menu of product options for a customer to select and/or design a custom product (step 230). It will be realized that the menu of options is a product specification tool that can be configured in a variety of ways for enabling a user to select, design, and/or specify the customized product the user desires to purchase. Depending on the user and type of customized product desired, creating a custom product design for ordering or specifying a customized food service product can be achieved by simply navigating the selection tools, either one time or multiple times through an iterative process.

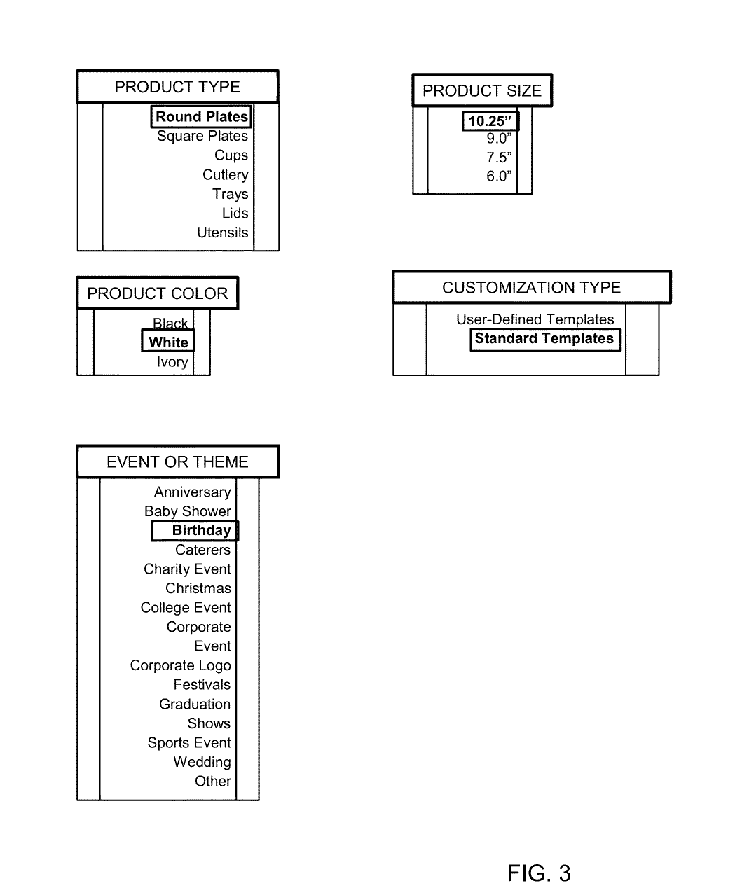

FIG. 3 provides a conceptual representation of an exemplary digital tool for facilitating design and specification of customized products by a user. The attributes for specifying user preferences include PRODUCT TYPE, PRODUCT SIZE, PRODUCT COLOR, CUSTOMIZATION TYPE, and EVENT OR THEME. Each of these attributes can have a variety of choices that may be selected by the user according to his/her preferences. In the exemplary embodiment according to FIG. 3, the selected options are shown surrounded by boxes. It will be recognized that the selection methodology depicted in FIG. 3 is exemplary, and that a provider of customized food service articles could configure it in a variety of ways to yield a variety of alternate embodiments. For instance, the selection menu can be arranged in the form of a drop-down menu or check boxes, or in some other format.

The specific selected options according to FIG. 3 indicate user selection of 10.25″ diameter, white round plates, customized using standard templates for a birthday theme. Reverting now to FIG. 2, once the user has selected and narrowed down preliminary options, the customer can be presented with digital images of various birthday templates for white round plates available in the system (step 235).

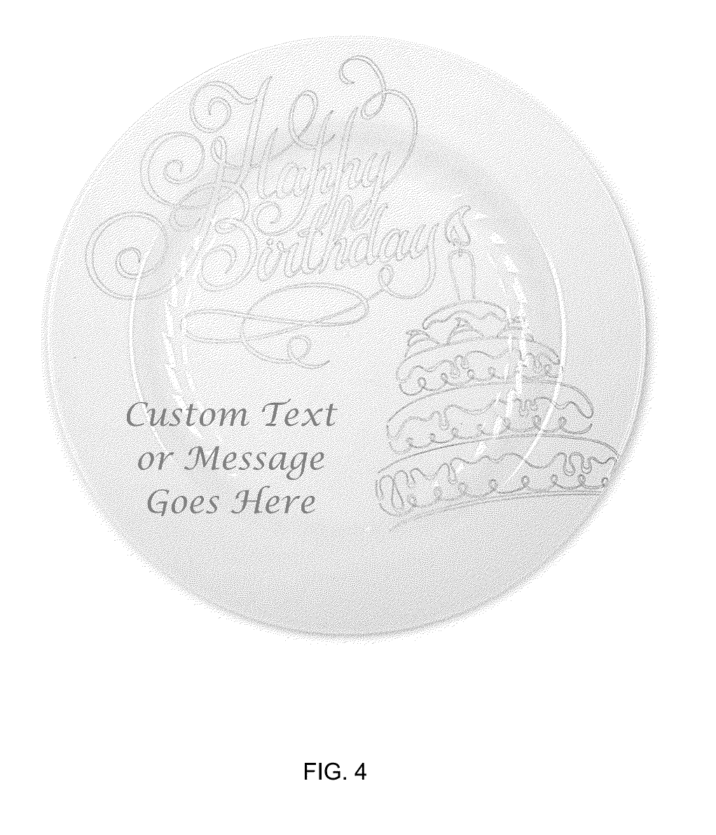

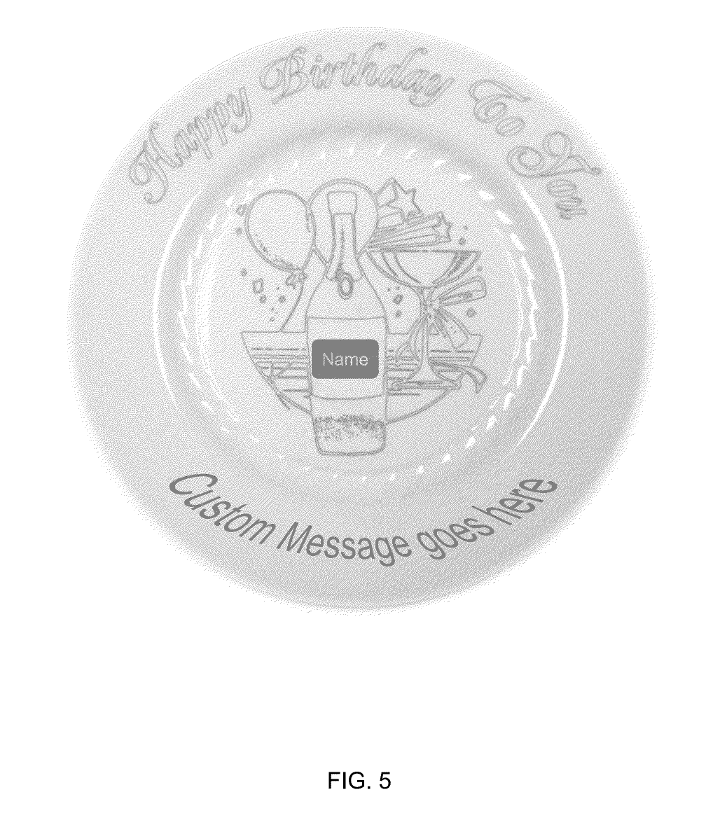

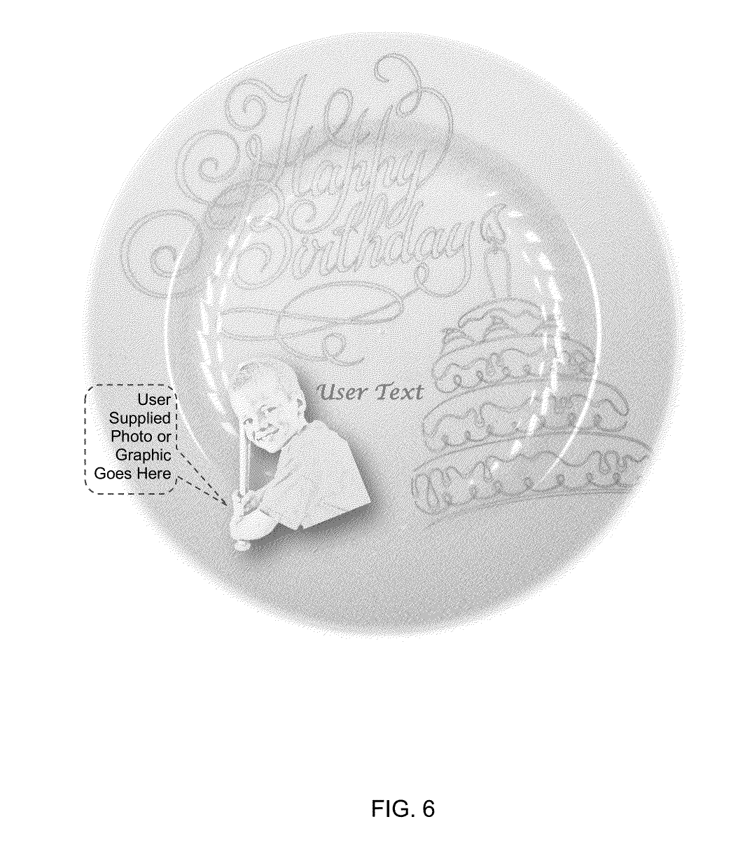

Two exemplary birthday templates are presented in FIG. 4 and FIG. 5, which show round white plates having areas for customization where a user or potential customer could insert his/her own message or custom text. One of the main objectives of providing theme templates is to provide the user with the convenience of quickly selecting a basic product style which can be customized by the user by simply providing textual input. However, it will be realized that customization of food service articles, according to the present invention, is not limited to placing text at a designated location on food service articles. A potential customer may want to place a graphic or photograph on the food service article in addition to text. An exemplary template according to an embodiment of the invention is shown in FIG. 6, wherein the customization includes a user-supplied photograph or graphic and user-supplied text. It will be realized that a commercial system may offer any number of theme templates rather than the ones shown here.

Reverting now to discussion relating to FIG. 2, once the system receives a selection of a template by the user and additional information in the form of text, graphic, image, or photograph for further customization within the constraints of the specific template selected by the user, the system can modify the template according to customer input (step 240). Thereafter, the system can provide a digital preview or “proof” of the customized product, and a quote for the custom product (step 245). In certain embodiments of the invention, a digital preview of the customized product as requested by the customer can be automatically generated by the system and provided to the customer. It will be realized that digital output for certain custom products may require further manipulation by the decorating system before a digital image can be made available to the customer. If the system cannot readily generate a digital output of the custom product, the system can notify the customer to proceed with the order with an option to approve the digital image of the customized product at a later time.

At step 250, the system seeks verification from the customer whether the customized product is acceptable or not. If the user is satisfied with the custom product output and the specifications and appearance of the customized product, the user can indicate that the custom product is acceptable and proceed with placing the order (step 265). If the user is not satisfied with the customized product output, the user may continue with the customization process by selecting another template (step 255), or may restart the entire selection process for customizing the food service product (step 260). In some embodiments, the user may be provided with an option to create and design customized products by utilizing the tools provided by the system, and saving or storing the customized product output and specification details in his or her account for ordering and/or modifying at a later time. Similarly, after placing an order the customer may have the option to store the design for future re-use, either with or without modification. It will be realized that the system provider can place certain limitations on user accounts with respect to storing unordered or ordered customized product designs on the system. For example, the system may limit the amount of memory space available to a user in his/her account for storing unordered and/or ordered customized product designs, and/or the system may set a limit on the allowable time period for storing unordered customized product designs in a user's account, and/or the system may place a limit on the number of customized product designs that can be held in an unordered or ordered state in a user's account.

In some embodiments, finalization of the order for customizing food service products in step 265 may also require receiving a pre-payment for the custom product, which can be handled via a credit card, a gift card, a debit payment, or electronic payment from a bank account, or from an online payment service such as PayPal. Alternately, the credit card information may be stored in the user account, and can be retrieved during the approval process.

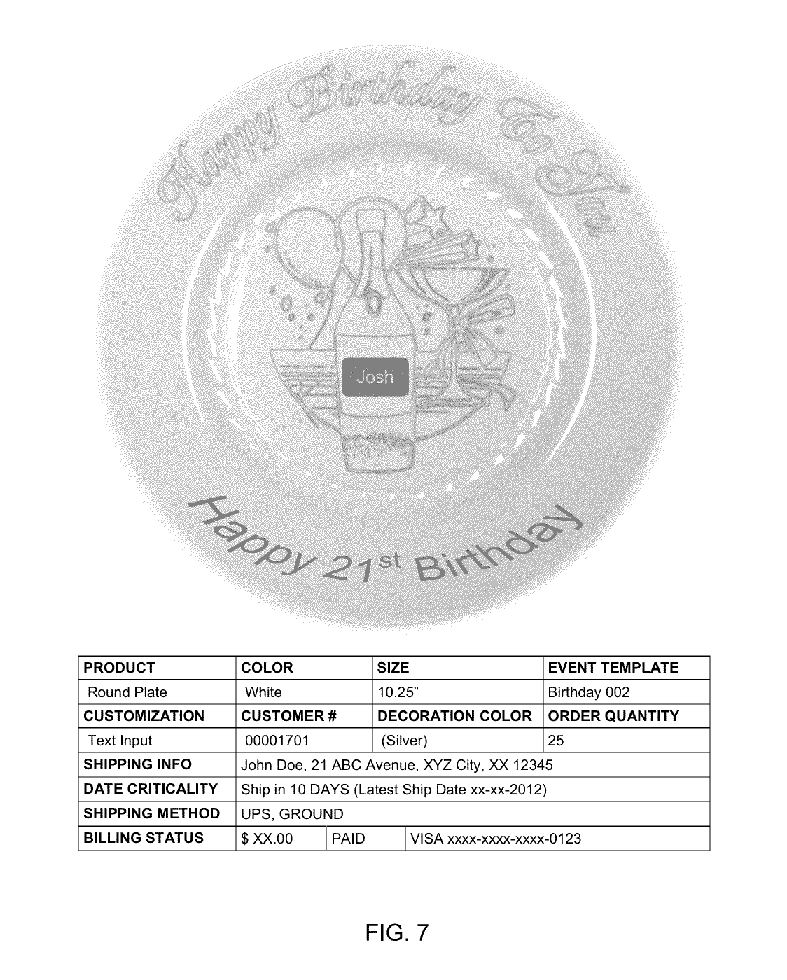

Once the ordering process is complete, the system transmits or forwards the customization order to the decorating system for processing (step 270). A completed order may take the form of an output file approved by the customer and may in addition include all relevant information that would allow decorating system 140 to fulfill the customer order. An exemplary representation of the output file that may be provided to the decorating system 140 is shown in FIG. 7. As shown in FIG. 7, the attributes and details specific to the order are listed in a tabular form. It will be appreciated that some of these attributes may be customer selectable, while others may not be selectable depending on the choice of other attributes. For instance, DECORATION COLOR is shown in FIG. 7 as a non-selectable attribute by placing the specified color in parentheses.

With reference to FIG. 2A, it will be appreciated by those skilled in the art that any input received from the customer may need to be converted into a file type that is processable by the decorating system 140 (step 275). As discussed above, conversion of input to a digital output may be automatic, or may require subsequent manipulation, depending on a variety of factors such as the type of output, complexity of the template, user perception, image resolution, and size of the product relative to the length of custom text. Examples of file conversions include converting a multi-color image to a grey scale image, converting a multi-color image to a line art or sketch, converting a grey scale image to line art, converting an image file format to a vector format, reversing portions of an image, removing the background of an image, changing the resolution of an image, etc.

Once the customer input is converted into a processable file, the customer order can be completed by running the customer order on a laser decorating system that manipulates the laser beam using a software controlled beam director (step 280). After the completion of the order, there may be a verification or quality assurance step for ensuring that the order is correct, and the customized food service articles comport with the placed order and customer input (step 285).

After the quality check, the order is shipped to the customer and shipping notification is sent electronically to the customer (steps 295 and 300).

While in the above description, an exemplary embodiment of the customizing system and method has been described for customizing round plates of a specific size and color for a certain theme, it will be recognized that the system can be extended to a variety of food service articles in any form or shape including trays, cups, cutlery, utensils etc.

In exemplary embodiments, the plastic food service article that can be customized by the system and method detailed herein above is made from a colored plastic that exhibits a localized change in color when exposed to laser radiation. The food service article can be either injection molded or thermoformed. Suitable plastic materials for forming or molding the food service articles may include polystyrene, polypropylene, polyethylene, polycarbonate, PET, PLA, ABS, SBC, SAN, PMMA, or a copolymer thereof, or a blend of two or more of the above resins or copolymers. The plastic is tinted with a colorant, pigment or dye typically used for coloring plastic; for example, the colorant can be a titanium dioxide colorant for white products, or carbon black colorant for black products. In embodiments, the colorant is selected to provide the appearance of china or another permanentware ceramic. In some embodiments, the food service article is free of any surface coatings, and laser markings are formed directly on the surface of the food service article. For white and light colored food service articles, the loading of the colorant in the plastic material is adjusted to provide an optical density of the colored plastic food service articles to be at least 1.0, and preferably greater than 1.2, for ensuring fast interaction with the laser beam. Higher optical densities allow the same marking intensity to be achieved at faster marking times. The inventors have obtained acceptable marking results on white plates with titanium dioxide pigment loading in the range of 2.5% to 5% by weight when using a laser marking system operating at 1062 nanometers and nominal power of 50 watts. It was found that the black articles exhibit much higher optical densities (greater than 3.0) even at 1% to 2% colorant loading. While higher colorant loadings may favorably impact marking speed or reduce marking time, they also tend to increase the overall cost of the article due to increased usage of the colorant in the plastic resin. The costs of the article can be optimized by establishing and experimenting with acceptable ranges of marking times and colorant loadings.

In embodiments, a YAG, a YLP, or a Fiber laser operating at a wavelength between 1060-1070 nanometers and preferably at 1062 nanometers or 1064 nanometers, is used for accomplishing the objects of this invention. Laser beams can be generated by supplying energy through a lamp or a diode. As is known in the art, the laser beam from the marking unit is guided or steered by a pair of mirrors through an optical lens which focuses the beam onto the plastic surface. Decorative markings and images can then be applied to the plastic foodservice article by appropriate deflection of the laser beam and modulation of its power. Different lenses can provide different spot size for the incident beam. If the spot size is too wide, then the laser energy will be distributed over a larger area, and the intensity of marking or contrast may be feeble. If the spot size is too small, the line thickness may be too thin for sufficient visual impact. Larger lenses provide larger spot sizes but also cover a larger area. Therefore, spot size must be reasonably large for achieving the optimum marking effect. According to certain embodiments of the invention, spot sizes in the range of 100 to 200 microns (0.1 to 0.2 mm) are deemed appropriate. The inventors have found that certain plastic materials such as PLA perform better or provide high contrast markings at smaller spot size compared to polystyrene, polypropylene, polyethylene and PET.

To achieve optimal marking effect within the shortest time period for reasons of cost and expediency, the incident laser beam hitting the surface of the food service article must be focused; therefore, the food service article must be placed at the right focal distance from the lens.

The food service article is exposed to a laser beam having sufficient power such that absorption by the plastic-colorant combination causes localized heating of the surface at the laser impact location, where the localized heating is sufficient to cause localized foaming and/or discoloration of the surface of the plastic article. The optimal laser power and exposure time will depend on the type of plastic used and on the type and amount of colorant included in the plastic. For each type of plastic and colorant, the optimal laser power and exposure time can readily be determined by applying different laser powers and exposure times to a sample of the plastic and noting a range of parameters for preventing excessive melting, charring or vaporization of the plastic substrate. Optimal exposure conditions will produce visible and well contrasted markings on both light-colored and dark-colored plastics. By manipulating various equipment variables, including laser power, marking speed, and resolution, surface roughness and texture of the decorated area can be controlled for achieving the desired visual appearance. It will be realized by those skilled in the art that the laser beam in most commercial marking system is not continuous, but pulsed rapidly at frequencies that can be as high as 80 kHz or 80,000 times per second.

In embodiments, application of a complete decorative pattern or image (as are illustrated in the figures) requires between a half-second and a few seconds. The beam deflection is controlled by a computer or other software-driven processor (step 104). If a series of plastic articles are decorated, it is therefore easy to transition between different decorations as often as every article, by simply providing appropriate instructions to the processor. One of the advantages of laser marking is that digital control of the marked pattern facilitates customization of food service articles and decorative patterns can be changed quickly compared to, for example, offset printing, which is a typical prior art method of printing these articles which is only practical for printing a non-varying decorative pattern on a relatively large number of articles for economic reasons. In some embodiments, two or more patterns can be sequenced in a continuous loop for creating an assorted batch of decorated food service articles.

As will become readily apparent from the description herein, a plastic food-service item that can be readily laser-decorated according to the present invention provides several advantages over prior methods for decorating food-service items, some of which are discussed above.

With reference to FIG. 5-7, using a 50 Watts, Pulsed Fiber laser operating at a wavelength of about 1062 nm, the inventors have found that a tinted disposable plastic food service article, such as a plastic plate, can be laser marked to emulate the look of a permanentware china plate. For instance, upscale chinaware often includes decorative marking in the form of silver or gold bands or other decorative artwork. The inventors have used a Fiber laser according to the present invention to decorate food service articles such as plates made of a plastic that have been tinted to resemble china, and have produced decorated plastic plates that simulate the appearance of ornately decorated chinaware having gold or silver markings without applying or using any metallic materials, inks, foils, or any other externally applied materials, and without adding any special or secondary pigments to the plastic. The markings on white plates, for example, as shown in FIGS. 4 and 5, offer a silver colored appearance, while the markings on black plates (not shown here) offer a gold colored appearance.

In particular, the marking pattern shown in FIG. 4 was obtained using a 50 Watts Pulsed Fiber laser operating at 1062 nanometers with a power setting of 100%, a frequency setting of 50%, a marking speed of about 1000 mm/sec, and resolution of 20 dots/mm. A 300 mm lens was used and the focal distance was about 28 inches. The white plate of FIG. 2 is 10.25 inches in diameter and was injection molded using polystyrene resin and titanium dioxide colorant. The titanium dioxide loading in the final article was about 3.5%. Marking time for this plate was about 1.5 seconds and marking exhibited a silver color. It is worth mentioning that laser radiation at these wavelengths and power is harmful to the human eyes and appropriate protective equipment must be worn when working with laser equipment and preferably laser marking should be conducted inside a suitably guarded enclosure that prevents harmful radiation from reaching the operator's eyes.

It has been generally noticed that black food service articles can be marked at faster speeds or shorter marking times compared to lighter colors, most likely due to higher absorptivity of the carbon black colorant.

The inventors have also discovered that one way to speed up the laser marking process and/or to achieve higher contrast markings is to construct the food service articles from a blend of two or more plastic resins, wherein one of the resin components has a lower melting or vaporization temperature than the other resin components. For example, a blend of about 2% to 5% by weight of linear low density polyethylene in a colored polystyrene material yields shorter marking times than colored polystyrene by itself

The ability to simulate the appearance of an ornately decorated permanentware china plate without using inks and foils provides several advantages. Since there is no risk of ink-migration into food, there is no risk of arcing or electrical hazards when the plate is used in a microwave, unlike a foil-stamped plate. Printing equipment changeover and associated clean-up is eliminated, no barrier overcoat is required, and much finer and more intricate patterns can be applied onto the plate surface, as compared to ink printing, without risk of ink-smearing. In addition, changeovers from one graphic or pattern to another can be readily accomplished without significant downtime or line-stoppages, so that product personalization and customization for various events and occasions becomes practically feasible and economically viable.

It will be appreciated that in printing or stamping a food-service article, the printed portions of the article have to be fully supported to allow exertion of pressure on the inked surface or master to cause transference of the pattern onto the article, requiring use of dedicated fixtures. Laser decoration of a food service article does not require that the plate be in contact with a physical surface during the decorating process. Any post-molding contamination from ink-carrying templates, stamping dies, or other hardware is thereby avoided. A particular advantage of the non-contact laser decoration method is that the plate surface to be decorated does not have to be substantially flat or maintained in a flat configuration during the decoration process.

In commercially available laser systems, the incidence of the laser beam on the article surface is controllable in accordance with the desired graphic or pattern using software, whereby the laser beam interacts with the plastic substrate and creates a mark in accordance with the intended artwork. If the surface of the article is shaped, the movements of the beam can be adjusted to compensate, thereby producing an undistorted image of the artwork on the shaped surface. Changing the artwork is achieved simply by loading a new file that changes the software commands, so that the pattern can be changed as frequently as every article without significant economic impact.

One of the aspects of the laser marking process is that the artwork file needs to be in an appropriate format to serve as suitable input for controlling laser beam deflection via the software program. CAD format files in, for example, DXF format have been found to yield acceptable results, but the choice of file format depends on the type of commercial laser unit and the specifications provided by the manufacturer of the laser marking equipment. It has been the experience of the inventors that typical image formats such as JPEG tend to result in longer marking times and conversion of images to line art and/or a vector format file results in a significant reduction in marking time. One of the advantages of vector format files is that images can be scaled without loss in quality.

Use of a high-intensity laser according to the present invention to irradiate the plastic substrate provides rapid local heating of the plastic substrate, as radiation from the laser beam is absorbed by the substrate and converted to thermal energy. Depending on the process parameters, type of plastic, colorant, and design pattern, absorbed radiation may induce decorated markings by causing foaming, carbonizing or charring, discoloration, and/or chemical changes in the plastic structure. The inventors have found that exposing dinnerware to laser radiation produces a moderate coloration that is suggestive of a metal such as silver, pewter or gold, without actually containing any metal. For example, in FIGS. 4 and 5 the white plate articles include markings that resemble silver colored ink. Of course, too much laser power or longer exposure to laser radiation could vaporize the plastic, resulting in engraving rather than marking

The 50 Watts Fiber laser unit used for decorating examples shown here yielded marking times for a typical plastic plate in some embodiments of between 0.5 seconds and 5 seconds. At least in some embodiments, the laser marked decoration produces an optically visible but relatively shallow plastic discoloration effect that is difficult to detect by touch, does not have an unpleasant feel, and does not raise concerns of any substance detaching from the plate surface and migrating into food during use. In other words, the markings can be safely placed in areas which are generally intended for food contact, such as the central area of the plate or a tray, and having sufficient durability to withstand mechanical, thermal and chemical challenges offered by various foods. Laser marked plates have been subjected to dishwasher cycles and have been used with a variety of foods. One of the appeals of the laser marking process is that the markings can be placed in food-contact areas without utilizing a barrier overcoat or a secondary protective layer.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for providing a decorated foodservice article, said method comprising the steps of:
receiving an input over a computer network for decorating a foodservice article;
converting said input to at least a file type, said file type being processable by a decorating machine computer system;
applying a visible marking pattern on a surface of said foodservice article in accordance with said processable file;
transforming said foodservice article to said decorated foodservice article, said application of said visible marking pattern being suitable for food contact; and
controlling at least one of location, size, and prominence of said marking pattern on said surface of said foodservice article.

2. The method of claim 1, comprising the additional step of:
evaluating said input prior to converting said input for at least one of artwork type, image resolution, file format, size, and font type.

3. The method of claim 1, wherein said step of applying said marking pattern is implemented by a laser beam.

4. The method of claim 1, wherein said foodservice article comprises a plastic material.

5. The method of claim 1, wherein said foodservice article comprises a paper substrate.

6. The method of claim 1, wherein said foodservice article comprises at least one of a plastic material, a paper substrate, and a metallic coating.

7. The method of claim 1, wherein said foodservice article comprises a first material component and a second material component, said first material component having higher laser absorptivity than said second material component.

8. The method of claim 1, wherein said visible marking pattern offers an appearance of printed ink without utilizing an ink composition.

9. The method of claim 1, wherein said visible marking pattern offers an appearance of a metallic coating without utilizing said metallic coating.

10. The method of claim 1, wherein said foodservice article comprises at least one of polystyrene, polyethylene, polypropylene, polycarbonate, PET, PLA, ABS, SAN, PMMA, and SBC.

11. The method of claim 1, wherein said foodservice article comprises at least a plastic material and at least a colorant.

12. The method of claim 1, wherein said visible marking pattern on said surface of the foodservice article is difficult to detect by human touch.

13. The method of claim 1, wherein said visible marking pattern on said surface of the foodservice article is detectable by human touch.

14. The method of claim 1, wherein said visible marking pattern on said surface of the foodservice article provides a gold appearance.

15. The method of claim 1, wherein said visible marking pattern on said surface of the foodservice article provides a silver appearance.

16. The method of claim 1, wherein said visible marking pattern on said surface of the foodservice article provides a pewter appearance.

17. The method of claim 1, wherein said visible marking pattern on said surface of the foodservice article provides a white appearance.

18. The method of claim 1, wherein said visible marking pattern on said surface of the foodservice article provides at least one of a gold appearance, a pewter appearance, and a silver appearance.

19. The method of claim 1, wherein said surface of said foodservice article is non-planar.

20. The method of claim 1, where said visible marking pattern is applied to a portion of the foodservice article comprising at least one of a flat surface, a non-planar surface, a single curvature surface, a multi-curvature surface, a fluted region, and a scalloped region.

21. A method for customizing a plastic foodservice article, said method comprising the steps of:
receiving an input over a computer network for customizing said plastic foodservice article from a customer;
converting said input into a form processable by a decorating machine computer system;
subjecting a surface of said plastic foodservice article to a laser beam, said laser beam having sufficient intensity to cause localized discoloration of said plastic foodservice article;
controlling said laser beam through a software-based beam director implemented on said decorating machine computer system; and
transforming said plastic foodservice article to customized plastic foodservice article by forming a visible marking pattern on said surface of said plastic foodservice article in accordance with said input received from said customer.

22. A method for customizing a plastic foodservice article, said method comprising the steps of:
offering a plurality of templates, over a computer network, for customizing said plastic foodservice article, said plurality of templates including at least a first template, said first template comprising at least a standard portion and a custom portion;
receiving, over said computer network, a selection of at least said first template and an input corresponding to said custom portion of said first template from a customer;
converting said first template into a custom file in accordance with said input, said custom file being in a form processable by a decorating machine computer system;
applying a marking pattern on a surface of said plastic foodservice article by a laser beam, said laser beam having sufficient intensity to cause localized discoloration of said plastic foodservice article;
controlling said laser beam through a software-based beam director implemented on said decorating machine computer system; and
transforming said plastic foodservice article to customized plastic foodservice article by forming a visible marking pattern on said surface of said plastic foodservice article in accordance with said input received from said customer.
